(19) United States
(12) Patent Application Publication
(10) Pub. No.: US 2010/0111566 A1
(43) Pub. Date: May 6, 2010

(54) PHOTOCONDUCTIVE DRUMS CONTROLLER

(75) Inventors: Junichi KATAYAMA, Shizuoka (JP); Hideaki FUKAYA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/610,883

(22) Filed: Nov. 2, 2009

Related U.S. Application Data
(60) Provisional application No. 61/112,108, filed on Nov. 6, 2008.

(51) Int. Cl. G03G 15/00

(52) U.S. Cl. 399/167

(57) ABSTRACT

An image forming apparatus aligns phases of plural photoconductive drums. In a ready mode, every time a predetermined time elapses, the image forming apparatus runs idle the plural photoconductive drums in a predetermined angle. The image forming apparatus uses timing of detecting either a leading end or a terminal end of a rib as a trigger for stopping the plural photoconductive drums after idling of the plural photoconductive drums.

### CROSS-REFERENCE TO RELATED APPLICATION

This application is based upon and claims the benefit of priority from provisional U.S. Application 61/112,108 filed on Nov. 6, 2008, the entire contents of which are incorporated herein by reference.

### TECHNICAL FIELD

The present invention relates to an image forming apparatus which reduces adverse effects of the environment on an image without generating any color shift of the image in a color printer, multi-function peripheral (MFP) or the like.

### BACKGROUND

In some of color image forming apparatuses as such MFPs and printers, the phases of plural photoconductive drums are aligned with each other in order to prevent a color shift of an image. When the plural photoconductive drums are stopped at the same position in order to align the phases, image quality may be lowered by the deterioration of a specified part on each photoconductive drum.

Thus, for example, JP-A-2008-76546 discloses an apparatus which stops plural photoconductive drums with a shift of a predetermined angle from the position where the photoconductive drums are previously stopped. Also, JP-A-2007-164136 discloses an apparatus which stops a monochrome photoconductive drum in line with the phase of color photoconductive drums after a monochrome print mode.

However, in the conventional apparatuses, when the plural photoconductive drums are stopped with their phases aligned at the end of printing, the position is only shifted by a predetermined angle from the previous stop position. After the plural photoconductive drums are stopped once with their phases aligned at the finishing of printing, the plural photoconductive drums continue stopping at the same position. Therefore, only a specified part on the plural photoconductive drums may be affected by ozone products generated in a charging device, a transfer device and so on, and by changes in temperature and humidity within the apparatus body, and image quality may be lowered.

In the color image forming apparatus, it is desirable to reduce the influence of ozone products and changes in temperature and humidity within the apparatus body on a specified part on the photoconductive drums, thus restrain deterioration of the specified part on the photoconductive drums, and acquire good image quality.

### SUMMARY

According to an aspect of the invention, the influence of ozone products and changes in temperature and humidity to photoconductive drums within the apparatus body are made even. Deterioration of the photoconductive drums is made even, and reduction in image quality is prevented.

According to an embodiment, an image forming apparatus includes plural image carriers, and a control unit which carries out phase alignment control to align phases of the plural image carriers and idling control to move the plural image carriers from a first stop position to a second stop position in a ready mode (The ready mode is a state where printing can immediately start.).

### DESCRIPTION OF THE DRAWINGS

FIG. 1 is an overall view of configuration showing an image forming apparatus according to an embodiment;

FIG. 2 is a schematic view of configuration showing an image forming station according to the embodiment;

FIG. 3 is a schematic perspective view showing a driving unit of photoconductive drums according to the embodiment;

FIG. 4 is a schematic perspective view showing a phase detection unit according to the embodiment;

FIG. 5 is a schematic explanatory view showing the operation of photoconductive drums in a monochrome mode according to the embodiment;

FIG. 6 is a schematic explanatory view showing the operation of photoconductive drums in a color mode according to the embodiment;

FIG. 7 is a graph showing continuous print time and ozone concentration according to the embodiment;

FIG. 8 is a graph showing image defect level with respect to leaving time of photoconductive drums according to the embodiment;

FIG. 9 is a block diagram showing a control system of photoconductive drums according to the embodiment;

FIG. 10 is a flowchart showing the start of a photoconductive drum idling process after the finishing of printing according to the embodiment;

FIG. 11 is a schematic explanatory view showing a first stop position and a second stop position, and the state until a photoconductive drum is stopped after a trigger according to the embodiment;

FIG. 12 is a flowchart showing the process of stopping the photoconductive drum at the second stop position according to the embodiment;

FIG. 13 is a schematic explanatory view showing the state until the photoconductive drum is stopped after a trigger of (1) according to the embodiment;

FIG. 14 is a schematic explanatory view showing the state until the photoconductive drum is stopped after a trigger of (2) according to the embodiment; and

FIG. 15 is a schematic explanatory view showing the state until the photoconductive drum is stopped after a trigger of (3) according to the embodiment.

### DETAILED DESCRIPTION

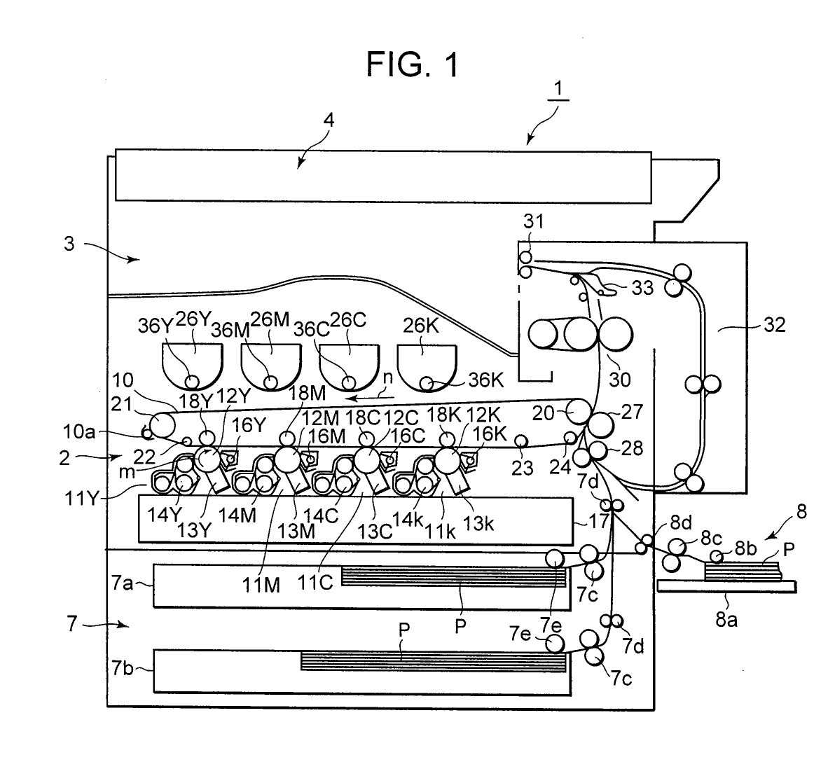

An embodiment will be described hereinafter. FIG. 1 is a schematic view of configuration of a color printer 1 as an image forming apparatus according to an embodiment. The color printer 1 has a printer unit 2 which forms an image, a paper discharge unit 3 which accumulates sheets P discharged from the printer unit 2, a scanner unit 4 which scans an original image, and a paper supply device 7 and a bypass paper supply device 8 which supply sheets P.

The printer unit 2 has four image forming stations 11Y, 11M, 11C and 11K of Y (yellow), M (magenta), C (cyan) and K (black) arranged in parallel along the lower side of an intermediate transfer belt 10. The image forming stations 11Y, 11M, 11C and 11K have photoconductive drums 12Y, 12M, 12C and 12K as image carriers, respectively. Each of the image forming stations 11Y, 11M, 11C and 11K forms Y (yellow), M (magenta), C (cyan) and K (black) toner images on the photoconductive drums 12Y, 12M, 12C and 12K, respectively. Each of the photoconductive drums 12Y, 12M and 12C forms a color image carrier. The photoconductive drum 12K forms a black image carrier.

The photoconductive drums 12Y, 12M, 12C and 12K rotate in the direction of arrow m. Around the photoconductive drums 12Y, 12M, 12C and 12K, chargers 13Y, 13M, 13C and 13K, developing devices 14Y, 14M, 14C and 14K, and photoconductor cleaners 16Y, 16M, 16C and 16K are arranged, respectively, along the direction of rotation.

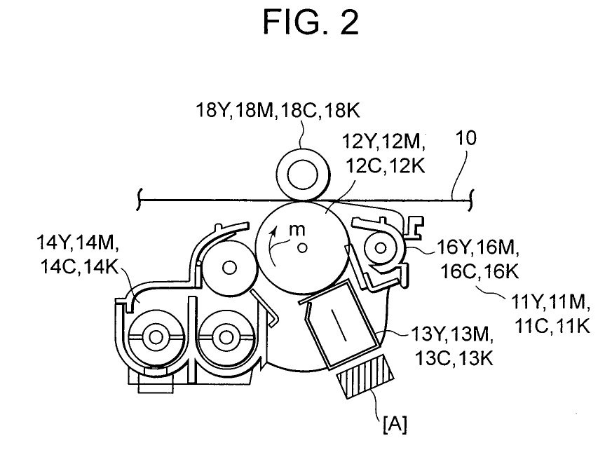

As shown in FIG. 2, in the image forming stations 11Y, 11M, 11C and 11K, photoconductive drums 12Y, 12M, 120 and 12K, the chargers 13Y, 13M, 13C and 13K, the developing devices 14Y, 14M, 14C and 14K, and the photoconductor cleaners 16Y, 16M, 16C and 16K may be integrated to form process cartridges. If process cartridges are formed, each process cartridge is made separate and integrally attached to and removed from the body of the color printer 1.

Between each chargers 13Y, 13M, 13C and 13K and each developing devices 14Y, 14M, 14C and 14K around each photoconductive drums 12Y, 12M, 12C and 12K, corresponding exposure light is emitted by a laser exposure device 17. The laser exposure device 17 scans the photoconductive drums 12Y, 12M, 12C and 12K in the axial direction with a laser beam emitted from a semiconductor laser element. By the emitting of the corresponding exposure light from the laser exposure device 17, electrostatic latent images are formed on the photoconductive drums 12Y, 12M, 12C and 12K, respectively. The developing devices 14Y, 14M, 14C and 14K supplies a toner to the electrostatic latent image on the photoconductive drum 12Y, 12M, 12C and 12K and visualizes the electrostatic latent image respectively. Each of the developing devices 14Y, 14M,14C and 14K carries out development using a two-component developer including a Y, M, C or K toner and a carrier.

Above the developing devices 14Y, 14M, 14C and 14K, toner cartridges 26Y, 26M, 26C and 26K are arranged, respectively, which house toners as Y, M, C and K replenishment developers for the developing devices 14Y, 14M, 14C and 14K. The toner cartridges 26Y, 26M, 26C and 26K has toner augers 36Y, 36M, 36C and 36K which carries the toner to the direction of the developing devices 14Y, 14M, 14C and 14K respectively.

The intermediate transfer belt 10 is tensioned by a backup roller 20, a driven roller 21, and the first to third tension rollers 22 to 24. The intermediate transfer belt 10 is turned in the direction of arrow n. The intermediate transfer belt 10 faces and contacts the photoconductive drums 12Y, 12M, 12C and 12K. At the positions facing the photoconductive drums 12Y, 12M, 12C and 12K on the intermediate transfer belt 10, primary transfer rollers 18Y, 18M, 18C and 18K are provided. Each primary transfer rollers 18Y, 18M, 18C and 18K performs primary transfer of each toner images formed on each photoconductive drums 12Y, 12M, 12C and 12K to the intermediate transfer belt 10. Each photoconductor cleaners 16Y, 16M, 16C and 16K removes and collects residual toners on each photoconductive drums 12Y, 12M, 12C and 12K after primary transfer.

A secondary transfer roller 27 faces a secondary transfer section on the intermediate transfer belt 10 supported by the backup roller 20. In the secondary transfer section, a predetermined secondary transfer bias is applied to the backup roller 20. In the secondary transfer section, the secondary transfer roller 27 transfers the toner image on the intermediate transfer belt 10 to the sheet P passes between the intermediate transfer belt 10 and the secondary transfer roller 27. The sheet P is supplied from a paper supply cassette 7a or 7b or the bypass paper supply device 8. After secondary transfer, the intermediate transfer belt 10 is cleaned by a belt cleaner 10a.

A pickup roller 7e, a separation roller 7c, a carrying roller 7d and a registration roller pair 28 are provided between the paper supply device 7 and the secondary transfer roller 27. A manual pickup roller 8b, a manual separation roller 8c and a manual carrying roller 8d are provided between a manual insertion tray 8a in the bypass paper supply device 8 and the registration roller pair 28. Along the direction of carrying the sheet P, a fixing device 30 is provided downstream of the secondary transfer roller 27. The fixing device 30 fixes the toner image transferred to the sheet Pin the secondary transfer section, to the sheet P. A gate 33 which allocates a sheet to the direction of a paper discharge roller 31 or to the direction of a re-carrying unit 32 is provided downstream of the fixing device 30. A sheet guided to the paper discharge roller 31 is discharged to the paper discharge unit 3. A sheet guided to the re-carrying unit 32 is guided again to the direction of the secondary transfer roller 27.

When the color printer 1 is in a monochrome mode, only the black photoconductive drum 12K is rotated in the direction of arrow m to form a monochrome image. When the color printer 1 is in a color mode, all the photoconductive drums 12Y, 12M, 12C and 12K are rotated to form a color image. In the color mode, all phases of the photoconductive drums 12Y, 12M, 12C and 12K are aligned.

For example, as a print process is started in the color mode, all the photoconductive drums 12Y, 12M, 12C and 12K start rotating in the direction of arrow m with the same phase. After each photoconductive drums 12Y, 12M, 12C and 12K is charged by each chargers 13Y, 13M, 13C and 13K, each exposure lights is emitted onto each photoconductive drums 12Y, 12M, 12C and 12K by the laser exposure device 17 and each electrostatic latent images corresponding to each exposure lights is formed on each photoconductive drums 12Y, 12M, 12C and 12K. Each toners is applied by each developing devices 14Y, 14M, 14C and 14K to each electrostatic latent images formed on each photoconductive drums 12Y, 12M, 12C and 12K, thus visualizing each electrostatic latent images. Each toner images formed on each photoconductive drums 12Y, 12M, 12C and 12K is transferred to the sheet P at the secondary transfer section via the intermediate transfer belt 10.

After being supplied from either the paper supply device 7 or the bypass paper supply device 8, the sheet P reaches the secondary transfer position synchronously with the toner images on the intermediate transfer belt 10. The fixing device 30 fixes the toner images on the sheet P. The sheet P after having the toner images fixed thereto is discharged to the paper discharge unit 3 via the paper discharge roller 31, or is carried again to the secondary transfer roller 27 via the re-carrying unit 32.

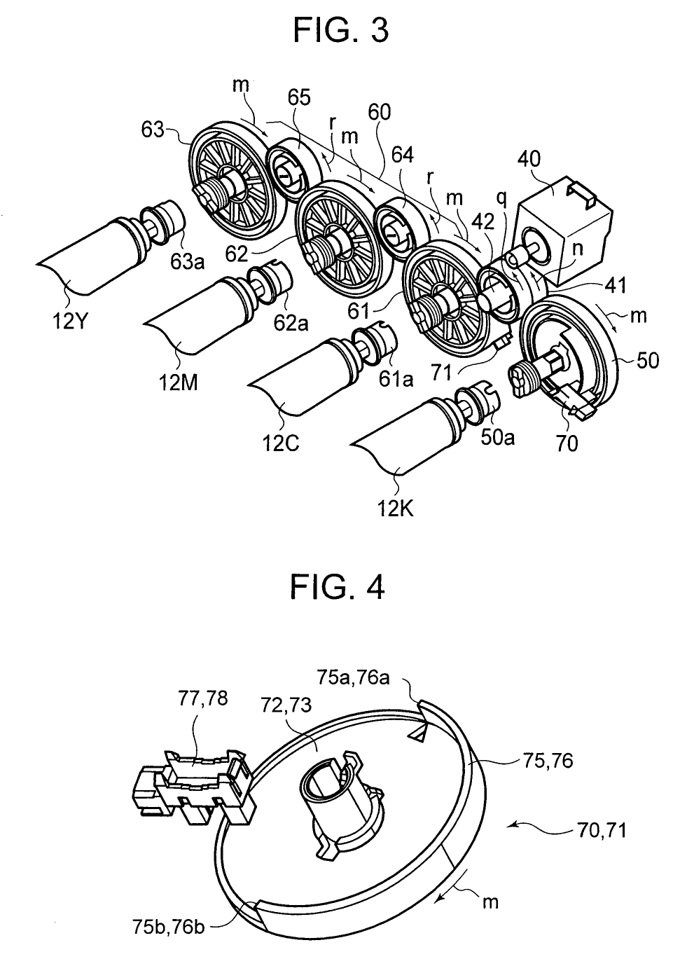

Next, the driving of the photoconductive drums 12Y, 12M, 12C and 12K will be described. The photoconductive drums 12Y, 12M, 12C and 12K have a drum motor 40 to the rear side, as shown in FIG. 3. The drum motor 40 has a first gear 41 which links to a gear 50 of the photoconductive drum 12K, and a second gear 42 which links to a gear array 60 of the photoconductive drums 12Y, 12M and 12C and transmits the driving of the first gear 41 to the gear array 60. The first gear 41 rotates in the direction of arrow n. The second gear 42 rotates in the direction of arrow q.

In the monochrome mode, the link between the second gear 42 and the first gear 41 is canceled. In the monochrome mode, only the first gear 41 rotates, thus rotating the gear 50 only. In the color mode, the second gear 42 links to the first gear 41. In the color mode, the first gear 41 and the second gear 42 rotate, thus rotating the gear 50 and the gear array 60.

As the first gear 41 rotates, the gear 50 rotates in the direction of arrow m. The gear 50 rotates the photoconductive drum 12K connected thereto via a coupling 50a, in the direction of arrow m. The gear array 60 has a gear 61 of the photoconductive drum 12C, a gear 62 of the photoconductive drum 12M and a gear 63 of the photoconductive drum 12Y. In the gear array 60, the gears 61, 62 and 63 are connected by connection gears 64 or 65 respectively.

As the second gear 42 rotates, the gears 61, 62 and 63 of the gear array 60 simultaneously rotate in the direction of arrow m. The gears 61, 62 and 63 rotate the photoconductive drums 12C, 12M and 12Y connected thereto via couplings 61a, 62a and 63a, respectively, in the direction of arrow m. The connection gear 64 rotates in the direction of arrow r and transmits the rotation of the gear 61 to the gear 62. The connection gear 65 rotates in the direction of arrow r and transmits the rotation of the gear 62 to the gear 63.

The gear 50 has a first phase detection unit 70 as a detection mechanism. The gear 61 has a second phase detection unit 71 as a detection mechanism. The first phase detection unit 70 and the second phase detection unit 71 have the same structure, though reversed in terms of the front and rear. Therefore, these phase detection units will be described with reference a common diagram of FIG. 4. The first and second phase detection units 70 and 71 have ribs 75 and 76 in an area covering ½ (180 degrees) of the circumferential edge of wheels 72 and 73 which rotate integrally with the gears 50 and 61, respectively. The ribs 75 and 76 forms an operating unit respectively. Each photo-sensor 77 and 78 which is switched by each ribs 75 and 76 is provided respectively around each wheels 72 and 73 as rotating body.

The photo-sensor 77 detects a leading end 75a and a terminal end 75b of the rib 75 and detects the phase of the photoconductive drum 12K. The photo-sensor 78 detects a leading end 76a and a terminal end 76b of the rib 76 and detects the phase of the photoconductive drums 12Y, 12M and 12C.

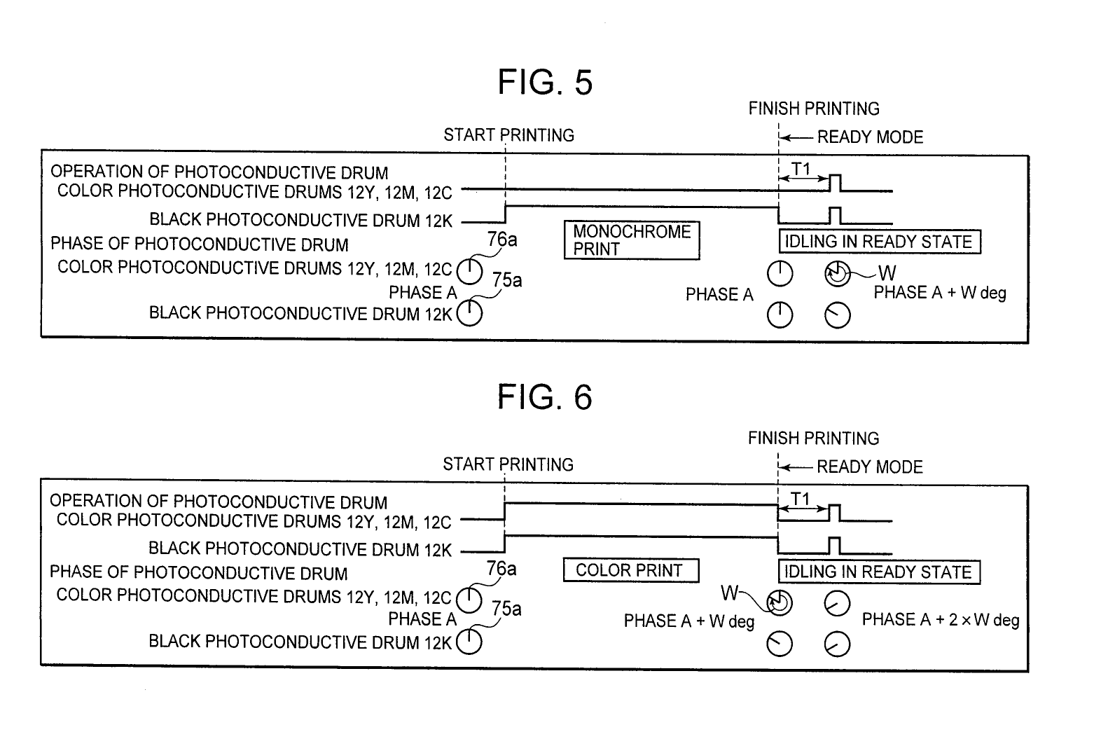

While the color printer 1 forms an image, the phase of the black photoconductive drum 12K detected by the first phase detection unit 70 coincides with the phase of the color photoconductive drums 12Y, 12M and 12C detected by the second phase detection unit 71. As shown in FIG. 5 and FIG. 6, at the time of starting printing, for example, the black photoconductive drum 12K is located at the position of phase A where the photo-sensor 77 detects the leading end 75a of the rib 75. The color photoconductive drums 12Y, 12M and 12C are located at the position of phase A where the photo-sensor 78 detects the leading end 76a of the rib 76. All the photoconductive drums 12Y, 12M, 12C and 12K are located at the position of phase A. The phases of the photoconductive drums are aligned.

As printing in the monochrome mode is started, only the black photoconductive drum 12K rotates. At the finishing of printing, the black photoconductive drum 12K stops at the position of phase A in line with the phase of the color photoconductive drums 12Y, 12M and 12C. As printing in the color mode is started, all the photoconductive drums 12Y, 12M, 12C and 12K rotate. At the finishing of printing, all the photoconductive drums 12Y, 12M, 12C and 12K stop at the position of phase A+W degrees, which is a position shifted from phase A by a predetermined angle (W degrees). In the color mode, all the photoconductive drums 12Y, 12M, 12C and 12K are aligned in phase though the phase at the finishing of printing is shifted from the phase at the start of printing.

In the color mode, the phase at the finishing of printing is shifted from the phase at the start of printing by W degrees. The next printing starts at phase A+W deg. The next shift angle is (W degrees)+(W degrees). If the shift angle exceeds 360 degrees because of add the shift angle sequentially, the phase is shifted by an angle as a result of subtracting 360 degrees from the shift angle, and the operation time is thus reduced. As the phase of the photoconductive drums 12Y, 12M, 12C and 12K at the stop position is shifted for every printing sequentially, the use of a specified part on the photoconductive drums 12Y, 12M, 12C and 12K at the print operation is avoided.

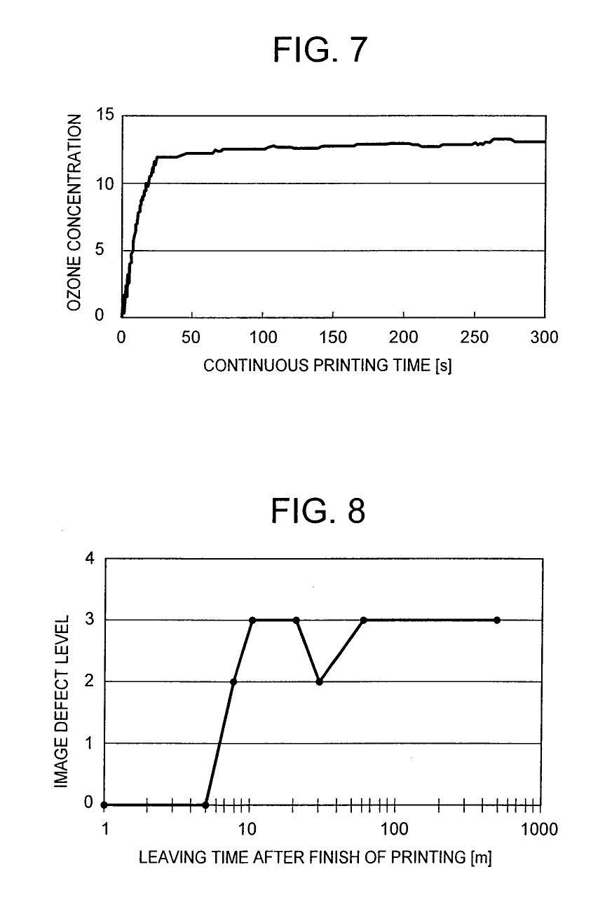

At the time of the above printing, the chargers 13Y, 13M, 13C and 13K generate ozone (O₃) between each chargers 13Y, 13M, 13C and 13K and each photoconductive drums 12Y, 12M, 12C and 12K because of charging. The generated ozone (O₃) is constantly discharged from the color printer 1. However, if a large number of sheets are printed and a large quantity of ozone (O₃) is generated, it takes time to discharge the ozone (O₃). The ozone (O₃) stays between the photoconductive drums 12Y, 12M, 12C and 12K and the chargers 13Y, 13M, 13C and 13K. The ozone (O₃) concentration in the color printer 1 in the case of continuous printing is, for example, as shown in FIG. 7. At the continuous printing time reaches approximately 25 seconds, the ozone (O₃) concentration exceeds 12. (The unit expressing ozone concentration is ppm. Using an ozone meter, the atmosphere is absorbed at the rate of 1.5 liter per minute and the ozone concentration is measured every 12 seconds.)

The staying ozone (O₃) generates oxides. If the photoconductive drums 12Y, 12M, 12C and 12K keep stopping at the same position, the influence of ozone (O₃) products and temperature and humidity changes is unevenly concentrated at a specified position on the photoconductive drums 12Y, 12M, 12C and 12K. The oxides generated by ozone (O₃) unevenly concentrate to adhere to the specified position on the photoconductive drums 12Y, 12M, 12C and 12K and create an oxide film on the surface of the specified position on the photoconductive drums 12Y, 12M, 12C and 12K. On the photoconductive drums 12Y, 12M, 12C and 12K, the electrostatic property in the oxide film part changes and may generate unevenness in image and hence an image defect.

For example, under the condition that the ozone (O₃) concentration is 12 in an area [A] (shaded in FIG. 2) immediately below the chargers 13Y, 13M, 13C and 13K, the relation between the leaving time of the photoconductive drums 12Y, 12M, 12C and 12K and the image defect level can be found as shown in FIG. 8. (In FIG. 8, image defect levels are defined as follows: image defect level 0 means that no defect can be found; image defect level 1 means that a professional user may notice the uneven concentration; image defect level 2 means that a general user may notice the uneven concentration but there is no practical problem; and image defect level 3 means that the uneven concentration is not practical at all.)

In an environment where the ozone (O₃) concentration is 12, according to FIG. 8, if the leaving time of the photoconductive drums 12Y, 12M, 12C and 12K is about 6 minutes or shorter, no adhesion of an oxide film to the surface of the photoconductive drums 12Y, 12M, 12C and 12K is observed and a satisfactory image having no fogging and no uneven concentration can be acquired. If the leaving time exceeds 6 minutes, uneven concentration gradually occurs in the image. Before the leaving time reaches 10 minutes, the image defect level reaches 3 and an unpractical level of image defect occurs.

In the embodiment, when the color printer 1 is in a ready mode, the photoconductive drums 12Y, 12M, 12C and 12K are idled by a predetermined angle according to the need. As the photoconductive drums 12Y, 12M, 12C and 12K are idled, the influence of ozone products generated by the staying ozone (O₃) and temperature and humidity changes on the photoconductive drums 12Y, 12M, 12C and 12K is made even.

In the color printer 1, for example, when the continuous printing time, as the amount of continuous image formation immediately before the transition from the print mode to the ready mode, exceeds time T2, and the continuous printing time after the transition to the ready mode exceeds time T1, the photoconductive drums 12Y, 12M, 12C and 12K are idled by W degrees. Also, the number of continuously printed sheets may be observed and the idling of the photoconductive drums 12Y, 12M, 12C and 12K may be carried out when the number of continuously printed sheets reaches a predetermined number of sheets or greater.

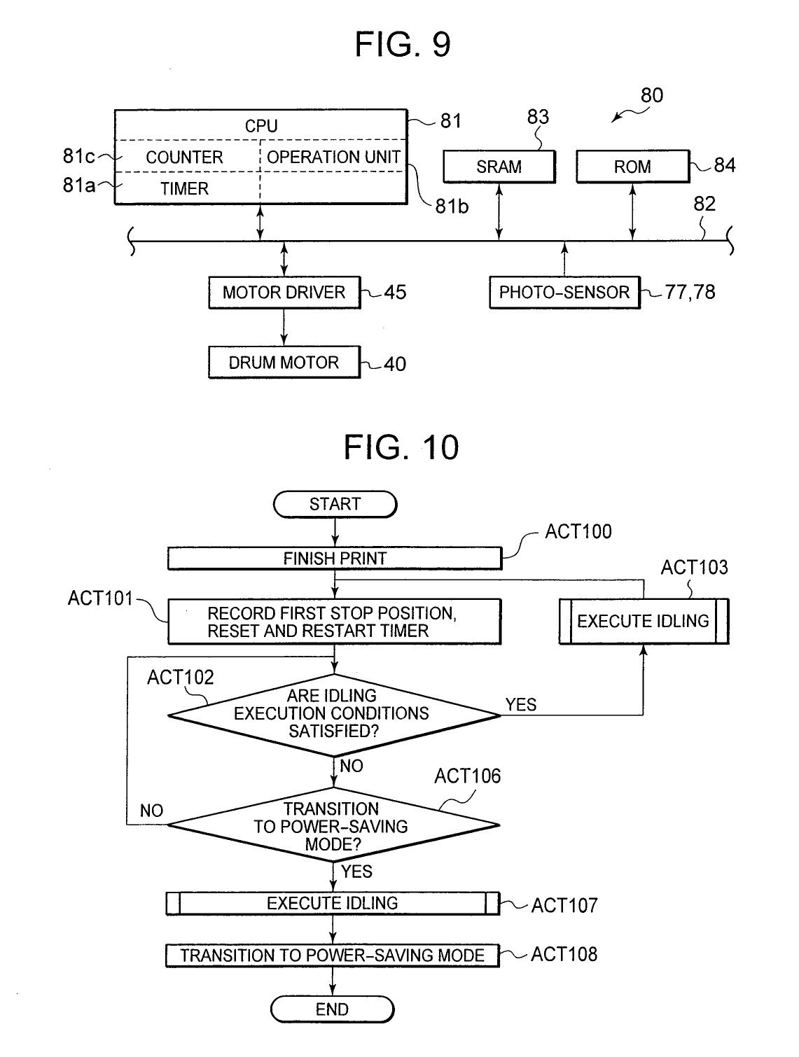

FIG. 9 shows a block diagram of a control system 80 mainly for driving control to idle the photoconductive drums 12Y, 12M, 12C and 12K. A CPU 81 which controls the entire color printer 1 has the photo-sensors 77 and 78, a motor driver 45 which drives the drum motor 40, and a static random access memory (SRAM) 83 and a read only memory (ROM) 84 as storage units, via an input-output (I/O) interface 82. The CPU 81 has a timer 81a, an operation unit 81b and a counter unit 81c.

The ROM 84 stores, for example, an idling program to idle the photoconductive drums 12Y, 12M, 12C and 12K. The SRAM 83 stores, for example, the first stop position of the photoconductive drums 12Y, 12M, 12C and 12K, the idling angle (W degrees) of the photoconductive drums 12Y, 12M, 12C and 12K, a threshold value T2 of continuous printing time, the elapsed time T1 in the ready mode, the time (D) required for the drum motor 40 to stop, and so on.

The start of the process of idling the photoconductive drums 12Y, 12M, 12C and 12K after the finishing of printing will be described with reference to the flowchart shown in FIG. 10. The elapsed time T1 in the ready mode, which is a condition that requires the idling of the photoconductive drums 12Y, 12M, 12C and 12K in the ready mode, is set to be shorter than the leaving time which causes an oxide film to be generated on the photoconductive drums 12Y, 12M, 12C and 12K and causes the generation an image defect to be started. However, if in case that the photoconductive drums 12Y, 12M, 12C and 12K are idled, the life of the photoconductive drums 12Y, 12M, 12C and 12K may be reduced by the influence of peripheral devices. Therefore, the idling of the photoconductive drums 12Y, 12M, 12C and 12K at a high frequency influences the life of the photoconductive drums 12Y, 12M, 12C and 12K. Thus, it is desirable that the elapsed time T1 has as large a value as possible within a period before an oxide film is generated on the photoconductive drums 12Y, 12M, 12C and 12K.

When the ozone concentration in the color printer is low, an image defect does not easily occur and therefore the photoconductive drums 12Y, 12M, 12C and 12K need not be idled in the ready mode. The continuous printing time T2 immediately before the transition to the ready mode, which is a condition that requires the idling of the photoconductive drums 12Y, 12M, 12C and 12K in the ready mode, is set in consideration of the influence of the idling on the life of the photoconductive drums 12Y, 12M, 12C and 12K and in consideration of the influence of ozone (O₃) in the color printer 1 on the electrostatic property of the photoconductive drums 12Y, 12M, 12C and 12K. The continuous printing time T2 may also be set separately for printing in the color mode and printing in the monochrome mode.

As the idling of the photoconductive drums 12Y, 12M, 12C and 12K is started and printing is finished in the color printer 1 (ACT 100), the stop position of the photoconductive drums 12Y, 12M, 12C and 12K at the finishing of printing is set as a first stop position. The first stop position is stored into the SRAM 83 and the timer 81a is reset once and then restarted (ACT 101). In ACT 102, it is determined whether the conditions (the elapsed time T1 in the ready mode and the continuous printing time T2) for executing the idling of the photoconductive drums 12Y, 12M, 12C and 12K are satisfied. In case that the continuous printing time immediately before exceeds T2 and the elapsed time in the ready mode exceeds T1 (Yes in ACT 102), the idling of the photoconductive drums 12Y, 12M, 12C and 12K is executed in ACT 103 and the processing returns to ACT 101. While the ready mode is maintained, when the execution conditions in ACT 102 are satisfied, the idling in ACT 103 is repeated.

In case that the conditions for executing the idling of the photoconductive drums 12Y, 12M, 12C and 12K are not satisfied in ACT 102 (No in ACT 102), it is determined whether transition to a power-saving mode should be made (the power-saving mode is a mode in which power supplied to constantly powered components such as the fixing device is lowered or cut, and the ready mode cannot be restored unless predetermined restoration procedures such as warm-up are taken in the power-saving mode.) Even without the lapse of the elapsed time T1, if transition to the power-saving mode is made (Yes in ACT 106), the idling of the photoconductive drums 12Y, 12M, 12C and 12K is executed in ACT 107. Then, the color printer 1 is shifted to the power-saving mode (ACT 108) and the idling of the photoconductive drums 12Y, 12M, 12C and 12K is finished.

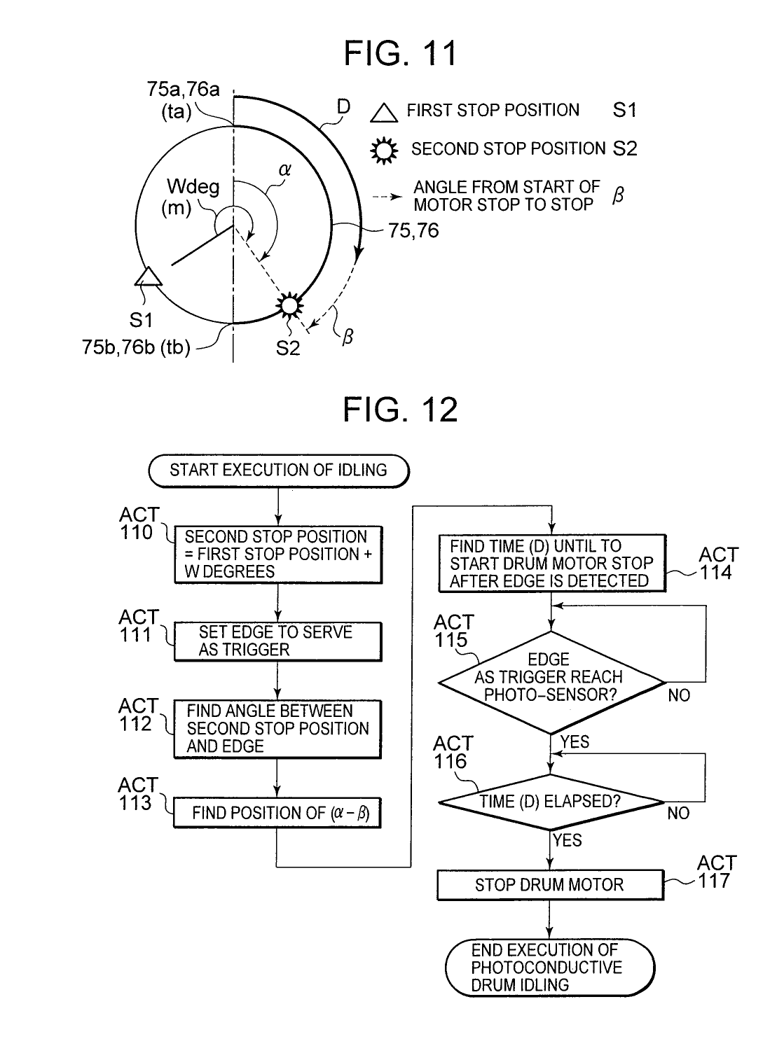

As the idling is executed in ACT 103 or ACT 107, the photoconductive drums 12Y, 12M, 12C and 12K are rotated from the current stop position by W degrees and then stopped. For example, an arbitrary position F of the photoconductive drums 12Y, 12M, 12C and 12K located at the current first stop position S1 is idled to a second stop position S2 as a result of rotating in the direction of arrow m by W degrees, and then stops there, as shown in FIG. 11.

In FIG. 11, the timing when the photo-sensors 77 and 78 detect the leading ends 75a and 76a of the ribs 75 and 76, respectively, is defined as ta, and the timing when the photo-sensors 77 and 78 detect the terminal ends 75b and 76b of the ribs 75 and 76, respectively, is defined as tb. It is now assumed that a trigger for the photoconductive drums 12Y, 12M, 12C and 12K to start idling and stop at the position where the arbitrary position F reaches the second stop position S2 is, for example, the timing ta. The angle from the leading ends 75a and 76a of the ribs 75 and 76 to the second stop position S2 of the arbitrary position F in the timing ta is α. The photoconductive drums 12Y, 12M, 12C and 12K are rotated by the angle α from the timing ta and then stopped.

However, for the drum motor 40, an angle β is needed for a movement from the start of the stop of the drum motor 40 until the drum motor 40 stops. Therefore, the motor driver 45 makes the start of stop of the drum motor 40 earlier in consideration of the angle β necessary for the stop of the drum motor 40. The motor driver 45 starts the stop of the drum motor 40 after the lapse of the time (D) required for the photoconductive drums 12Y, 12M, 12C and 12K to rotate by an angle (α−β) from the timing ta.

The time (D) is calculated using the following equation (1).

Time(D)=diameter of photoconductive drum×π×{angle(α−β)}/360/circumferential speed of drum motor (1)

The second stop position S2 is found by adding W degrees to the first stop position S1 stored in the SRAM 83. In case of repeating ACT 101 to ACT 103 of FIG. 10, the second stop position S2 found in a previous idling is set as the first stop position in a subsequent idling. Therefore, in the subsequent idling, (W degrees×2) is added to the first stop position S1 of the previous idling, thus finding a subsequent second stop position S2. In case that the angle added to the first stop position exceeds 360 degrees, an angle obtained by subtracting 360 degrees from the original angle is added and the second stop position S2 is thus found. With the subtraction of 360 degrees, the operation time of the idling is reduced and the influence of the idling on the life of the photoconductive drums 12Y, 12M, 12C and 12K is reduced.

The process of starting the rotation of the arbitrary position F on the photoconductive drums 12Y, 12M, 12C and 12K from the first stop position S1 and then stopping the arbitrary position Fat the second stop position S2 reached by rotating W degrees will be described with reference to the flowchart shown in FIG. 12. The black photoconductive drum 12K stops, based on the detection of the leading end 75a or the terminal end 75b of the rib 75 by the first photo-sensor 77 in the first phase detection unit 70, as a trigger. The color photoconductive drums 12Y, 12M and 12C stop, based on the detection of the leading end 76a or the terminal end 76b of the rib 76 by the second photo-sensor 78 in the second phase detection unit 71.

In stopping the photoconductive drums 12Y, 12M, 12C and 12K, the angle required for the stop of the drum motor is taken into account. The time (D) until the photoconductive drums 12Y, 12M, 12C and 12K start the stop of the drum motor 40 after the photo-sensors 77 and 78 detects the ends of the ribs 75 and 76respectively is set to be earlier by the angle β required for the stop of the drum motor 40.

A W degrees is added to the current first stop position S1 and the target second stop position S2 is thus set (ACT 110). It is set whether the leading ends 75a, 76a or the terminal ends 75b and 76b of the respective ribs 75 and 76 are used as the trigger for stopping the arbitrary position F on the photoconductive drums 12Y, 12M, 12C and 12K at the second stop position S2 (ACT 111).

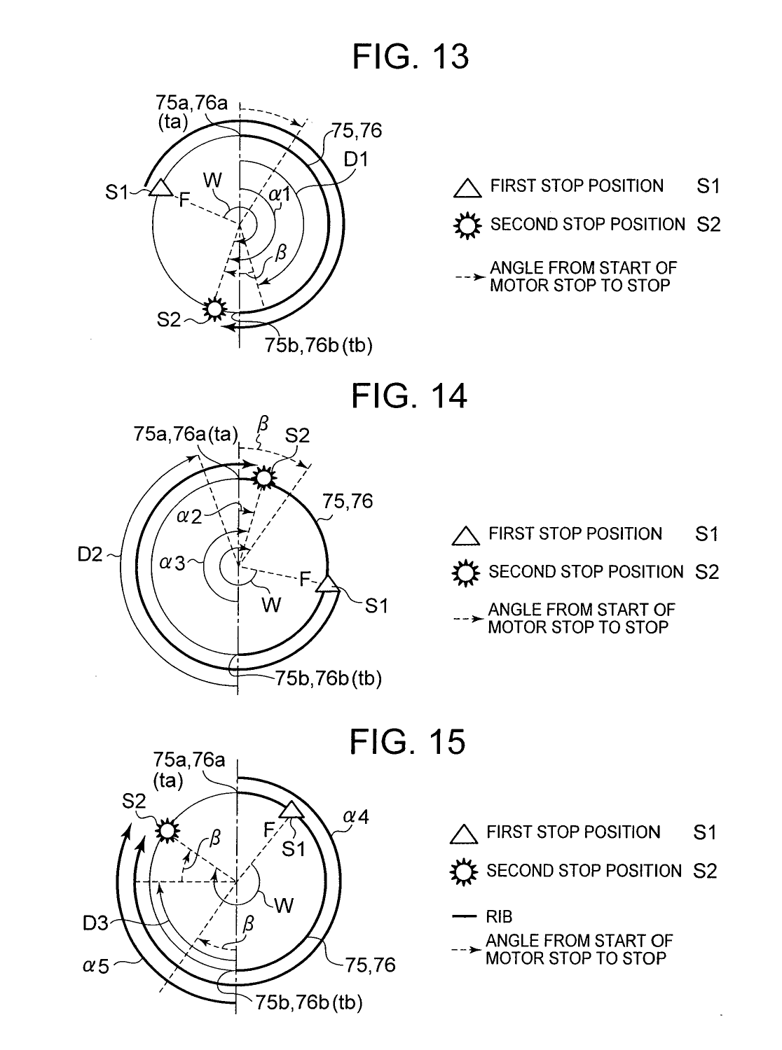

In ACT 111, (1) at the photo-sensors 77 and 78 detect the leading ends 75a and 76a of the ribs 75 and 76, respectively, as shown in FIG. 13, the angle from the leading ends 75a and 76a of the respective ribs 75 and 76 to the second stop position S2 is assumed α1. In case that the angle α1 is greater than the angle β, the motor driver 45 stops the drum motor 40, based on the detection of the leading ends 75a and 76a by the photo-sensors 77 and 78, respectively, as a trigger. It is assumed that the timing when the photo-sensors 77 and 78 detect the leading ends 75a and 76a of the respective ribs 75 and 76 is ta. The motor driver 45 starts the stop of the drum motor 40 after the elapse of the time (D) required for the rotation of the photoconductive drums 12Y, 12M, 12C and 12K by the angle (α1−β) after the timing ta.

In ACT 111, (2) at the photo-sensors 77 and 78 detect the leading ends 75a and 76a of the ribs 75 and 76, respectively, as shown in FIG. 14, angle from the leading ends 75a and 76a of the respective ribs 75 and 76 to the second stop position is assumed α2. If the angle α2 is smaller than the angle β, the motor driver 45 cannot be stop the drum motor 40 at the second stop position S2 after the photo-sensors 77 and 78 detect the leading ends 75a and 76a, respectively. In the case of FIG. 14, the motor driver 45 stops the drum motor 40, based on the detection of the terminal ends 75b and 76b of the respective ribs 75 and 76 by the photo-sensors 77 and 78, as a trigger. It is assumed that the timing when the photo-sensors 77 and 78 detect the terminal ends 75b and 76b of the respective ribs 75 and 76 is tb. At the photo-sensors 77 and 78 detect the terminal ends 75b and 76b, respectively, the angle from the terminal ends 75b and 76b of the respective ribs 75 and 76 to the second stop position S2 is α3. The motor driver 45 starts the stop of the drum motor 40 after the elapse of the time (D2) required for the rotation of the photoconductive drums 12Y, 12M, 12C and 12K by the angle (α3−β) after the timing tb.

In ACT 111, (3) “in case that the angle α4 from the leading ends 75a and 76a to the second stop position S2 is large at the timing ta of detecting the leading ends 75a and 76a by the photo-sensors 77 and 78, respectively” and “in case that the angle α5 from the terminal ends 75b and 76b to the second stop position S2 is greater than the angle β at the timing tb of detecting the terminal ends 75b and 76b by the photo-sensors 77 and 78, respectively” as shown in FIG. 15, the motor driver 45 stops the drum motor 40, based on the timing tb as a trigger. The motor driver 45 starts the stop of the drum motor 40 after the elapse of the time (D3) required for the rotation of the photoconductive drums 12Y, 12M, 12C and 12K by the angle (α5−β) after the timing tb. The idling time of the photoconductive drums 12Y, 12M, 12C and 12K is shortened and the influence on their life is reduced.

After the trigger for the motor driver 45 to stop the driver motor 40 is set according to one of the above situations (1) to (3) in ACT 111, the angle α from the photo-sensors 77 and 78 to the second stop position S2 is found at the timing ta or the timing tb (ACT 112). Then, the position of the angle (α−β) is found (ACT 113). The time (D) until the stop of the drum motor 40 is started after the ends of the ribs 75 and 76 are detected is found (ACT 114). As either the leading ends 75a and 76a or the terminal ends 75b and 76b set as the trigger in ACT 111 reach the photo-sensors 77 and 78 (Yes in ACT 115), the processing goes to ACT 116. The time (D) calculated in ACT 114 is passed from the timing to or the timing tb (Yes in ACT 116), the motor driver 45 stops the drum motor 40 (ACT 117) and the process of stopping the photoconductive drums 12Y, 12M, 12C and 12K finishes.

As the time T1 passes when the color printer 1 is in the ready mode after the end of printing, the photoconductive drums 12Y, 12M, 12C and 12K idle by W degrees from the first stop position S1 and stop at the second stop position S2. Both in the monochrome mode shown in FIG. 5 and in the color mode shown in FIG. 6, all the photoconductive drums 12Y, 12M, 12C and 12K rotate in the direction of arrow m with their phases aligned. The arbitrary position F on the photoconductive drums 12Y, 12M, 12C and 12K is shifted.

In the embodiment, if ozone (O₃) stays between the photoconductive drums 12Y, 12M, 12C and 12K and the chargers 13Y, 13M, 13C and 13K, the photoconductive drums 12Y, 12M, 12C and 12K are idled by W degrees every time the time T1 passes in the ready mode. A specified part on the photoconductive drums 12Y, 12M, 12C and 12K is thus prevented from being continuously affected by ozone (O₃). The influence of ozone (O₃) on the photoconductive drums 12Y, 12M, 12C and 12K is made even and variance in the electrostatic property of the photoconductive drums 12Y, 12M, 12C and 12K is restrained. Thus, a satisfactory image having uniform image quality is acquired.

In the embodiment, when the photoconductive drums 12Y, 12M, 12C and 12K are idled, either the leading ends 75a and 76a or the terminal ends 75b and 76b of the ribs 75 and 76 are set as a trigger to stop the photoconductive drums 12Y, 12M, 12C and 12K. The idling time to idle the photoconductive drums 12Y, 12M, 120 and 12K is thus reduced and a long life is provided for the photoconductive drums 12Y, 12M, 12C and 12K.

The invention is not limited to the above embodiment and various changes and modifications can be made without departing from the scope of the invention. For example, the continuous printing time T2 which requires the idling of the image carriers and the time T1 to start the idling of the image carriers in the ready mode are not limited. The rotation angle in the case of moving the image carriers from the first stop position to the second stop position is not limited, either. Moreover, the mechanism for rotating plural image carriers and aligning their phases is not limited. A phase detection unit may be provided for each of the plural image carriers and the phases of all the image carriers may be thus aligned. The phase alignment of the plural image carriers may be carried out immediately before the start of image formation, instead of at the end of image formation.

What is claimed is:

1. An image forming apparatus comprising:
plural image carriers; and
a control unit which carries out phase alignment control to align phases of the plural image carriers and idling controls to move the plural image carriers from a first stop position to a second stop position in a ready mode.

2. The apparatus according to claim 1, wherein the second stop position is a position reached as a result of rotation from the first stop position by a predetermined angle.

3. The apparatus according to claim 2, wherein the control unit sets the second stop position as a new first stop position, and repeats the movement of the plural image carriers from the first stop position to the second stop position every predetermined time in the ready mode.

4. The apparatus according to claim 1, wherein the control unit moves the plural image carriers from the first stop position to the second stop position before transition from the ready mode to a power-saving mode is made.

5. The apparatus according to claim 1, wherein the control unit moves the plural image carriers from the first stop position to the second stop position when a predetermined time elapses after transition to the ready mode is made.

6. The apparatus according to claim 1, wherein the control unit moves the plural image carriers from the first stop position to the second stop position when a quantity of continuous image formation reaches a predetermined quantity before transition to the ready mode is made.

7. The apparatus according to claim 1, further comprising a detection mechanism which detects the phases of the plural image carriers, and a storage unit which stores the first stop position of the plural image carriers.

8. The apparatus according to claim 1, wherein the control unit aligns the phases of the plural image carriers in termination of image forming process.

9. An image forming apparatus comprising:
plural image carriers having a black image carrier and a color image carrier;
a first phase detection portion which detects a phase of the black image carrier;
a second phase detection portion which detects a phase of the color image carrier; and
a control unit which carries out phase alignment control to align the phases of the black image carrier and the color image carrier, and idling controls to move the plural image carriers from a first stop position to a second stop position in a ready mode.

10. An image forming method comprising:
moving plural image carriers from a first stop position to a second stop position in a ready mode; and
aligning phases of the plural image carriers.

11. The method according to claim 10, wherein the second stop position is set by adding a predetermined angle to the first stop position.

12. The method according to claim 10, wherein the plural image carriers are moved from the first stop position to the second stop position before transition from the ready mode to a power-saving mode is made.

13. The method according to claim 10, wherein the plural image carriers are moved from the first stop position to the second stop position when a predetermined time elapses after transition to the ready mode is made.

14. The method according to claim 10, wherein the plural image carriers are moved from the first stop position to the second stop position when a quantity of continuous image formation reaches a predetermined quantity before transition to the ready mode is made.

15. The method according to claim 10, wherein at the time of moving the plural image carriers to the second stop position, the plural image carriers are stopped, base on detects an operation part which interlocked with rotation of the plural image after starts the moving of the plural image carriers.

16. The method according to claim 15, wherein the detection of the operation part is carried out plural time at equal intervals while the plural image carriers rotate once.

17. The method according to claim 16, wherein the plural image carriers are stopped, base on detects the operation part at first time after starts the moving of the plural image carriers.

18. The method according to claim 17, wherein the plural image carriers are stopped, base on detects the operation part in next time in case that a moving time from the first time of detection of the operation part to the plural image carriers reach the second stop position is shorter than a time which required for stopping a motor of the plural image carriers after starts the moving of the plural image carriers.

19. The method according to claim 16, wherein the plural image carriers are stopped, base on detects the operation part which closer to the second stop position after starts the moving of the plural image carriers.
